(19) United States
(12) Patent Application Publication
(10) Pub. No.: US 2015/0314634 A1
(43) Pub. Date: Nov. 5, 2015

(54) PERSONALIZED MARKING TOOLS AND ASSOCIATED SYSTEMS AND METHODS

(71) Applicant: Katherine Elizabeth Riffle Roper, Woodinville, WA (US)

(72) Inventor: Katherine Elizabeth Riffle Roper, Woodinville, WA (US)

(21) Appl. No.: 14/679,964

(22) Filed: Apr. 6, 2015

Related U.S. Application Data
(60) Provisional application No. 61/975,250, filed on Apr. 4, 2014.

(51) Int. Cl. B43K 31/00; B43K 19/02

(52) U.S. Cl. CPC B43K 31/00; B43K 19/02

(57) ABSTRACT

Marking tool systems are disclosed herein. One aspect of the present technology, for example, is directed toward a marking tool system that includes a plurality of marking tools. At least some of the marking tools can individually include a unique, customizable marking tool graphic on its respective outer surface. The marking tool system can further include a housing configured to carry the marking tools. The housing can include an opening at a front portion of the housing that is configured to display the marking tool graphics.

### TECHNICAL FIELD

The present technology relates generally to marking tools and associated systems. Some embodiments, for example, are directed to writing utensils and associated systems, as well as methods of use and manufacture.

### BACKGROUND

Certain occasions, such as first day of school, graduation, marriage, birthdays, teams, dinner party, weekly poker night, etc. bring together one or more persons. Often times in such settings it is desirable to commemorate the event, both to enhance the experience and also to create memories. Likewise, groups of people can hold a special meaning(s) to an individual. As such, many individuals can benefit from having a symbolic representation of that group or occasion. Also, marking tools have been used for centuries as therapeutic devices. For example, “play therapy” is one effective method of psychotherapy for children. In play therapy, children express their experiences and feelings through play, which can include drawing and/or coloring.

### BRIEF DESCRIPTION OF THE DRAWINGS

Many aspects of the present technology can be better understood with reference to the following drawings, Furthermore, components can be shown as transparent in certain views for clarity of illustration only and not to indicate that the illustrated component is necessarily transparent. The components in the drawings are not necessarily to scale. Instead, emphasis is placed on illustrating clearly the principles of the present technology.

FIG. 1 is a front perspective view of a marking tool system configured in accordance with the present technology.

FIG. 2 illustrates a method for creating a marking tool system on a website, the method and website configured in accordance with the present technology.

### DETAILED DESCRIPTION

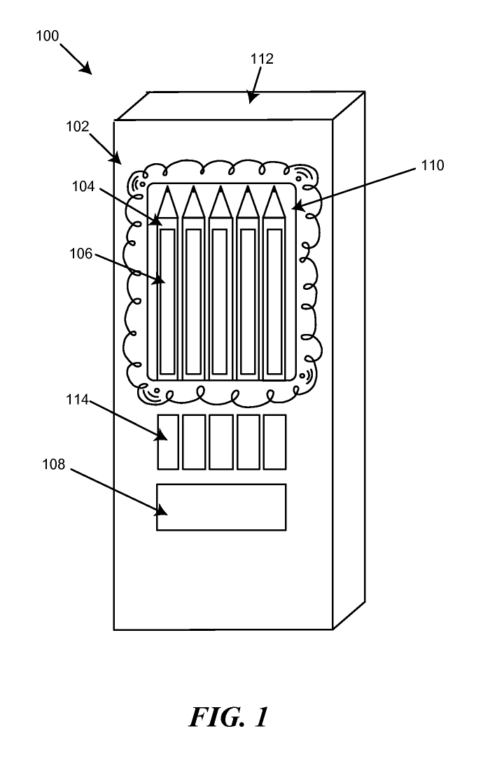

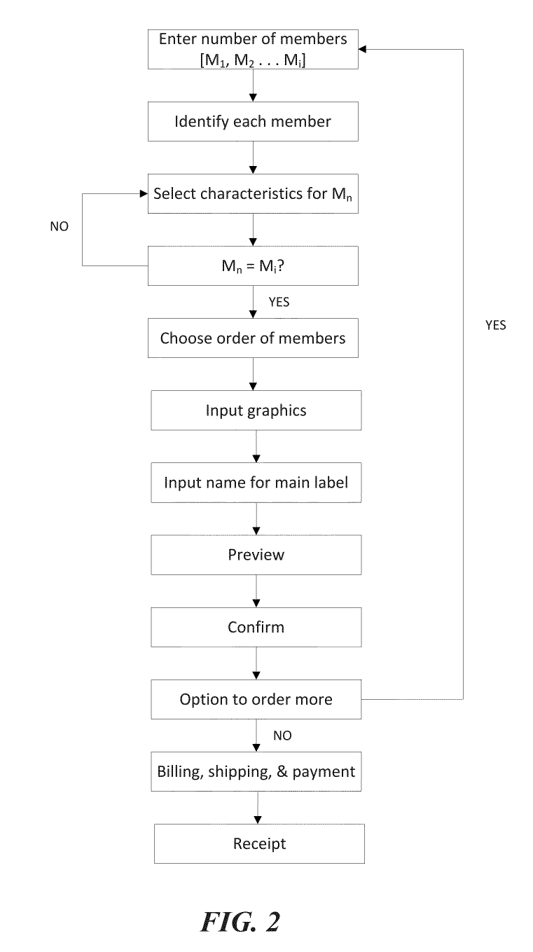

The present technology is directed to marking tools and associated systems and methods. Some embodiments of the present technology, for example, are directed to writing tools and associated systems and methods, Specific details of several embodiments of the technology are described below with reference to FIGS. 1 and 2. Additionally, some embodiments of the technology can have different configurations, components, or procedures than those described herein. For example, although the present technology is illustrated and explained with respect to a writing utensil, marking tools not commonly used to write with (such as a paintbrush) are also within the scope of the present technology. A person of ordinary skill in the art, therefore, will accordingly understand that the technology can have other embodiments with additional elements, or the technology can have other embodiments without several of the features shown and described below with reference to FIGS. 1 and 2.

FIG. 1 is a front perspective view of a marking tool system 100 configured in accordance with the present technology. The marking tool system 100 can include a housing 102 configured to carry one or more marking tools 104. As used herein, a “marking tool” refers to any instrument configured to change the appearance of an object. For example, a marking tool can be a pencil, pen, marker, crayon, spray bottle, scissors, paint brush and the like.

The housing 102 can have a flap 112 at a top portion that is moveable between open and closed positions. The housing 102 can also have an opening 110 at a front portion. The opening 110 can be configured to display one or more graphics 106 carried by the marking tools 104 when positioned within the housing 102. One or more portions of the housing can also include additional graphics. For example, as shown in FIG. 1, a front portion of the housing 102 can have one or more member graphics 114 that are aligned with or correspond to a marking tool 106 on display through the opening 110. The member graphics 114 can include any person, animal, place, symbol, or object customized by the user (discussed in greater detail below). A front portion of the housing 102 can also include a. label graphic 108. The label graphic 108 can communicate the significance of the collection of members (e.g., “Kelly's Family”, etc.), communicate a message (e.g., Happy Graduation!, etc.), and/or display any person, animal, place, object and/or symbol desired by the user. In other embodiments, the member graphics 114 and/or label graphic(s) 108 can be positioned anywhere on the exterior or interior of the housing. Although the housing 102 shown in FIG. 1 has a rectangular shape, the housing 102 can have other shapes, sizes and/or configurations. The housing 102 can he made of cardboard, plastic, metal and other suitable materials.

Each marking tool 104 can have one or more graphics 104 displayed on at least a portion of the exterior of the respective marking tool 104, For example, in some embodiments the graphic 106 can be directly integrated with the marking tool 104 (e.g., etched, printed, painted, etc, on or within the exterior material of the marking tool 104). In a particular embodiment, the graphic 106 can be printed on a separate material that is permanently affixed to the marking tool 104 (e.g., a wrap), in yet other embodiments, the marking tool 104 can include a fixation element (e.g., Velcro, snap-fit pin, button, adhesive, etc.) that removably attaches to a complementary fixation element that is coupled to the graphic 106. As such, a user can remove the graphic 106 at will and/or trade graphics between marking tools 104.

The graphic 106 can include any person, animal, symbol, place and/or object. In some embodiments, the graphic 106 can be selected from (discussed in more detail below) a list of pre-generated options on a website or other selection means, which includes cartoon representations, as well as linear depictions, graphic illustrations, photographs or other means of depicting a person, animal, symbol, place and or object. In a particular embodiment, the user can upload his or her own graphic and/or photograph to be used as the graphic 106, the graphic 114, graphic 108, as well as/or on the marking tool 104. The graphics 106 can be related by group of people (e.g., family, friends, sports team, workplace, etc.), experience (e.g., graduation, wedding, engagement, new baby, etc.) and/or any unifying characteristic meaningful to the user.

FIG. 2 illustrates one embodiment of a method carried out by a website configured. in accordance with the present technology. The website can be configured to facilitate the customization and/or personalization of the marking tools and/or marking tool system by a user. As shown in FIG. 2, a user can be prompted (by the website) to enter the number of members. The number of members can correspond to the number of marking tools desired for placement within the housing 102. In some embodiments, one or more marking tools can be purchased and/or designed for use and/or delivery separate from the housing 102. Next, a user can be prompted to identify each member. The identity of each member, for example, can eventually be displayed on a front portion of the housing 102 as the member graphic 114 (FIG. 1). The user can pick from a list of names provided by the website, such as “mom”, “dad”, “brother”, “sister”, “grandma”, “aunt”, “dog”, “friend”, etc. Instead of or in addition to the pre-populated list on the website, the user can be prompted to enter his or her own text and/or graphic. Once the members are identified, the user can be prompted to select various characteristics for each member (e.g., tall, short, long hair, short hair, brown eyes, blue eyes, glasses, mustache, type of animal, etc.). Next, the user can be prompted to enter or select a text or graphic for the label graphic 108 (FIG. 1). Additionally, a user can be prompted to select the specific order of marking tools 104 within the housing 102 such that the display of graphics 106 through the opening 110 has a particular theme or look (e.g., for a graduation, the graduate would be positioned at the middle of the marking tools 104, for a family, the marking tools 104 can be arranged in age order, etc.) The theme or look can be selected by the user to fit the interest and desire of the user.

Once all of the details have been finalized, the website can display a preview of the marking tool system 100, and prompt the user to confirm his or her satisfaction with the appearance of the marking tool system 100. Should the user find the preview acceptable, the website can then prompt the user to either make another marking tool and/or marking tool system, to generate a card or other related product that incorporates the marking tool and/or marking tool system or proceed to billing, shipping, and payment. Finally, once the user has submitted a payment through the website, the website can display a receipt for the user and/or email a receipt to the user.

It should be noted that the present technology can be configured to include more or less than the stages illustrated in FIG. 2 and can be in any order (not just the order shown in FIG. 2).

From the foregoing, it will be appreciated that specific embodiments of the invention have been described herein for purposes of illustration, but that various modifications may be made without deviating from the scope of the invention. Accordingly, the invention is not limited except as by the appended claims.

1-2. (canceled)

3. A marking tool system, comprising:
a plurality of pencils, each having an outer surface including a different, customizable marking graphic, wherein the marking graphic is a person, animal, event, and/or object that is unique to a particular user;
a rectangular housing configured to carry the pencils, wherein the housing includes:
a front portion having an outer surface;
an opening at the front portion such that, when the pencils are positioned within the housing such that the corresponding marking graphics are facing towards the front portion and substantially aligned with the opening, the marking graphics are displayed through the opening;
a plurality of customizable housing graphics on the outer surface, wherein each housing graphic:
has a corresponding marking graphic,
includes text that communicates a relationship between the individual marking graphics, and
is configured to be aligned along a short dimension of the housing with the pencil having the corresponding marking graphic when the pencils are positioned within the housing such that the marking graphics are displayed through the opening; and
a flap positioned along a top portion of the housing, wherein the flap is moveable between an open position and a closed position.

4. A marking tool system, comprising:
a plurality of marking tools, each having an outer surface, wherein at least some of the marking tools individually include a marking tool graphic on its respective outer surface, and wherein each marking tool graphic includes a person, animal, event, symbol, and/or object that is unique and customizable to a user;
a housing configured to carry the marking tools, wherein the housing includes:
an outer surface having a personalized housing graphic that includes at least one of a member graphic and a label graphic,
a flap positioned along a top portion of the housing, wherein the flap is moveable between an open position and a closed position, and
an opening at a front portion of the housing, wherein, when the marking tools are positioned within the housing, the opening is configured to display the marking tool graphics.

5. The marking tool system of claim 4 wherein the marking tools are writing utensils.

6. The marking tool system of claim 4 wherein the marking tools are pencils.

7. The marking tool system of claim 4 wherein the marking tool graphics are printed onto the respective marking tools.

8. The marking tool system of claim 4 wherein the marking tools graphics are etched onto the respective marking tools.

9. The marking tool system of claim 4 wherein an outer surface of the housing includes a member graphic.

10. The marking tool system of claim 4 wherein an outer surface of the housing includes a member graphic, and wherein the member graphic is at least one of a person, animal, symbol, and object.

11. The marking tool system of claim 4 wherein an outer surface of the housing includes a member graphic positioned adjacent the opening such that, when one of the marking tools having a marking tool graphic is positioned within the housing such that the marking tool graphic is displayed through the opening, the member graphic and the marking tool graphic align to complement one another.

12. The marking tool system of claim 4 wherein an outer surface of the housing includes a member graphic and a label graphic.

13. The marking tool system of claim 4 wherein an outer surface of the housing includes a label graphic.

14. The marking tool system of claim 4 wherein an outer surface of the housing includes a label graphic, and wherein the label graphic communicates a relationship between the individual marking tools graphics.

15. The marking tool system of claim 4 wherein the label graphic represents an event.

16. The marking tool system of claim 4 wherein the label graphic is related to a familial relationship.

17. The marking tool system of claim 4 wherein an inner surface of the housing includes a member graphic.

18. The marking tool system of claim 4 wherein:
an inner surface of the housing includes a member graphic, and
an outer surface of the housing includes a member graphic.

19. The marking tool system of claim 4 wherein:
an inner surface of the housing includes a member graphic, and
an outer surface of the housing includes a member graphic and a label graphic.

20. The marking tool system of claim 4 wherein:
an inner surface of the housing includes a label graphic, and
an outer surface of the housing includes a member graphic.

21. The marking tool system of claim 4 wherein the housing has a rectangular shape.
